(19) United States
(12) Patent Application Publication
(10) Pub. No.: US 2016/0029820 A1
(43) Pub. Date: Feb. 4, 2016

(54) Restaurant System

(71) Applicant: HEINEMACK GMBH, Nürnberg (DE)

(72) Inventor: Michael Mack, Fuerth (DE)

(21) Appl. No.: 14/777,478

(22) PCT Filed: Mar. 12, 2014
(86) PCT No.: PCT/DE2014/000130

§ 371 Date: Sep. 15, 2015

(30) Foreign Application Priority Data
Mar. 15, 2013 (DE) 10 2013 102 687.7

(51) Int. Cl. A47F 10/06; B65G 11/02

(52) U.S. Cl. CPC A47F 10/06; B65G 11/023

(57) ABSTRACT

The invention relates to a restaurant system including at least one working area for cooking and/or preparing food and/or drinks, at least one guest area. The working area and guest area are connected via a transport system for food and/or drinks The transport system, at least in some sections by means of the force of gravity, is designed to transport food and/or drinks from the working area to the guest area. The transport system includes a sliding rail system including one or a plurality of sliding rail paths and/or including at least one sliding rail. The sliding rails form sliding rail surfaces, and provision is made for transport means, which includes guide components having sliding surfaces. The sliding surfaces and/or the sliding rail surfaces have a profile for improving the sliding properties of the transport means.

The invention relates to a restaurant system (also: catering system) according to the preamble of claim 1.

Such a restaurant system comprises at least one working area for cooking and/or preparing food and/or drinks and at least one guest area, in particular comprising one or a plurality of tables for restaurant guests. The working area and the guest area are connected via a transport system for food and/or drinks. The transport system is designed to transport food and/or drinks from the working area to the guest area. The transport of food and/or drinks from the working area to the guest area takes place via the transport system at least in sections by means of the force of gravity. The transport system comprises or is a sliding rail system comprising one or a plurality of sliding rail paths and/or comprising at least one sliding rail, wherein the sliding rails form sliding rail surfaces, and wherein provision is made for transport means, in particular sliding supports and/or sliding devices, wherein the transport means comprise guide components comprising sliding surfaces. Such a restaurant system is known from DE 10 2005 059 188 B4 and EP 1 833 331 B1.

A restaurant system hereby does not only refer to systems for restaurants in the narrower sense, but, in general, to systems for all types of catering, thus also mobile or fixedly installed food stands, beer gardens, fast-food restaurants and drive-in restaurants, for example, in addition to restaurants and taverns. A restaurant system furthermore also refers to a drivable serving trolley, which can be pushed from table to table, for example in restaurants or children's hotels, so as to serve the food and/or drinks on or to the respective table in a spectacular manner, e.g. driving through a looping. In general, drivable serving or snack systems, for example systems, which are designed as trailers or as self-propelled mechanisms, comprising a corresponding setup as restaurant systems in terms of the invention.

For example, the working area is an area, which comprises kitchen and/or bar. It can be a food stand or simply also a simple space for making or preparing the food and/or drinks, for example. The working area can furthermore simply also be the area, in which food and/or drinks are placed into or onto the transport system, respectively, as can be the case in the case of the above-mentioned serving trolley, for example.

The guest area is the area, in which the guests of the restaurant, food stand, beer garden, etc. stay. Typically, tables and chairs are available here. However, it can also be a counter or a drive-in area, at which guests have food and/or drinks delivered to their car. However, in the case of a food stand, for example, guest area also refers to a simple dispensing area for food and/or drinks, at which the guests receive their food and/or drinks.

In the case of known systems, a reduction of the sliding properties of the transport means occurs due to contaminations of the sliding rail surfaces and/or of the sliding surfaces of the transport means. Dust and/or dirt deposits as well as the abrasion products of the sliding surfaces themselves lead to an increase of the acting frictional forces, which always increases over the operating time. This can lead to interferences in response to the transport of the food and/or drinks by means of the force of gravity.

The instant invention is thus based on the object of specifying a new restaurant system, in particular a restaurant system comprising improved sliding properties of the transport means.

This object is solved by means of the features of claim 1. Advantageous designs and further developments are specified in the dependent claims.

The restaurant system according to the invention is characterized in that the sliding surfaces and/or the sliding rail surfaces have a profile for improving the sliding properties of the transport means.

Profile refers to a surface structure, in the case of which elevations and/or depressions of the surface are provided.

The advantages of the invention lie in particular in that, while the transport means slide, the frictional forces on the sliding surfaces and/or sliding rail surfaces are reduced by providing a profile. Furthermore, the abrasion products on the sliding surfaces and/or sliding rail surfaces is also reduced, whereby fewer contaminations are caused on the sliding surfaces and sliding rail surfaces. In addition, dirt and abrasion products can collect in the depressions, in which it has no effect or at least a slight effect on the sliding properties. The dirt and/or the abrasion products can furthermore be discharged via the depressions.

According to a further development of the invention, the profile is formed by elevations, for establishing contact between sliding rails and transport means, and/or by depressions, for reducing the frictional surface and/or for discharging dirt and/or abrasion products.

A further development of the invention provides for the elevations and/or depressions to be formed parallel or vertically to the center axis or to run helically about the center axis.

Preferably, elevations and depressions alternate, so that a profile is formed.

Provision can be made for the elevations and/or depression to be formed with a cross section, which is semicircular and/or semi oval and/or sinusoidal and/or triangular and/or trapezoidal. The elevations and/or depression can be formed with a cross section, which has the same width or a different width.

According to a further development, the profile forms at least one or at least two or at least three or more elevations and/or depressions.

The number of the elevations and/or depressions determines the size of the frictional surface between sliding surface and sliding rail surface and thus ultimately the acting frictional forces.

Preferably, in particular in the event that the elevations and/or depressions are formed parallel to the center axis, provision is made for one, two or three elevations and/or depressions. The formation of one, two or three elevations and/or depressions has the advantage that, on the one hand, the frictional surfaces are kept as small as possible and that, at the same time, a level of stability, which is as high as possible, is reached in response to the connection of sliding rails and transport means.

The formation of one, two or three elevations and/or depressions would also be suitable for the use of roller guides instead of the provided sliding rails.

If provision is made for roller guides, a preferred further development of the invention is that the one or two or three elevations and/or depressions are formed parallel to the center axis and in an upper area of the guide components. The upper area is thereby the area, which is in contact with the running surfaces of the rollers of the roller guides.

Provision can also be made for only a single elevation to be formed in the center of the upper area of the guide components. This design alternative is advantageous in particular if the sliding rail system comprises sliding rails as well as roller guides.

In the event that the elevations and/or depressions are formed vertically to the center axis, the profile is preferably formed by means of a plurality of elevations and/or depressions, in particular more than three elevations and/or depressions.

According to a design alternative, provision is made on the sliding surfaces and/or sliding rail surfaces for profile means, which are arranged on or at least partially in the guide components and/or sliding rails, for generating a profile.

The advantages of the profile means are in particular that they can be replaced. Worn or contaminated profile means can be replaced by new profile means in this manner. The worn or contaminated profile means can be repaired afterwards so as to make it possible to use them again.

Preferably, the profile means on the one hand and guide components and/or sliding rails on the other hand differ with regard to their material, in particular with regard to the sliding properties or frictional coefficients of their material, respectively.

This has the advantage that the profile means can consist of a material, which can have particularly good or at least better sliding properties than the material of the transport means or of the sliding rails themselves, respectively, possibly in the case of higher material costs, whereas the material of the transport means or of the sliding rails, respectively, can be selected in particular with regard to the material costs, without or at least with a slight focus on the sliding properties.

Provision can furthermore be made for the guide components and/or sliding rails to have recesses for receiving the profile means, wherein the recesses are formed parallel or vertically to a center axis of the guide components or run helically about the center axis.

For example, the profile means can be clamped and/or hooked and/or clipped into the recesses. The profile means can likewise be arranged in the recesses by means of a press fit.

For example, the recesses are formed so as to have a substantially trapezoidal cross section.

The trapezoidal cross section can make it possible to click the profile means into the recesses. In the alternative, the profile means can also be inserted into the trapezoidal grooves lengthwise, wherein the trapezoidal cross section prevents the profile means from falling out or slipping out.

An advantageous further development provides for the profile means to have a sliding section and a connection section, wherein the shape of the connection section corresponds to the recesses of the guide components and/or the sliding rails and is provided for connection to the guide components and/or the sliding rails, and wherein the sliding section is formed to have a semicircular and/or semi oval and/or sinusoidal and/or triangular and/or trapezoidal cross section, so as to improve the sliding properties of the transport means.

Provision can furthermore be made for the sliding section of the profile means, in the installed state of the profile means, to form the elevation of the profile, and/or for the sliding surface and/or sliding rail surface to embody the depression of the profile.

Preferably, the guide components encompass the sliding rails at least partially; in particular, they encompass at least half of the sliding rail circumference, preferably at least two thirds of the sliding rail circumference.

Provision can also be made for the transport means to be formed for the transport of containers, in particular pots and/or dishes, preferably sliding bowls and/or sliding plates and/or sliding pots and/or sliding pans and/or glasses and/or cups and/or bottles and/or carafes and/or fast food packaging, for food and drinks, wherein the containers can preferably be placed into or onto the transport means in a stable manner.

With regard to the further design of the restaurant system, for example with regard to rails and rail systems, transport aids and containers for the food and/or drinks, reference is made to the restaurant systems described in DE 10 2005 059 188 B4 and EP 1 833 331 B1. The features of restaurant systems described in these publications can also be realized in the case of the restaurant system according to the invention.

The invention will be specified in more detail below also with regard to further features and advantages by means of the description of exemplary embodiments and with reference to the enclosed drawings.

FIG. 1 shows an exemplary embodiment of a restaurant system according to the invention in a schematic view;

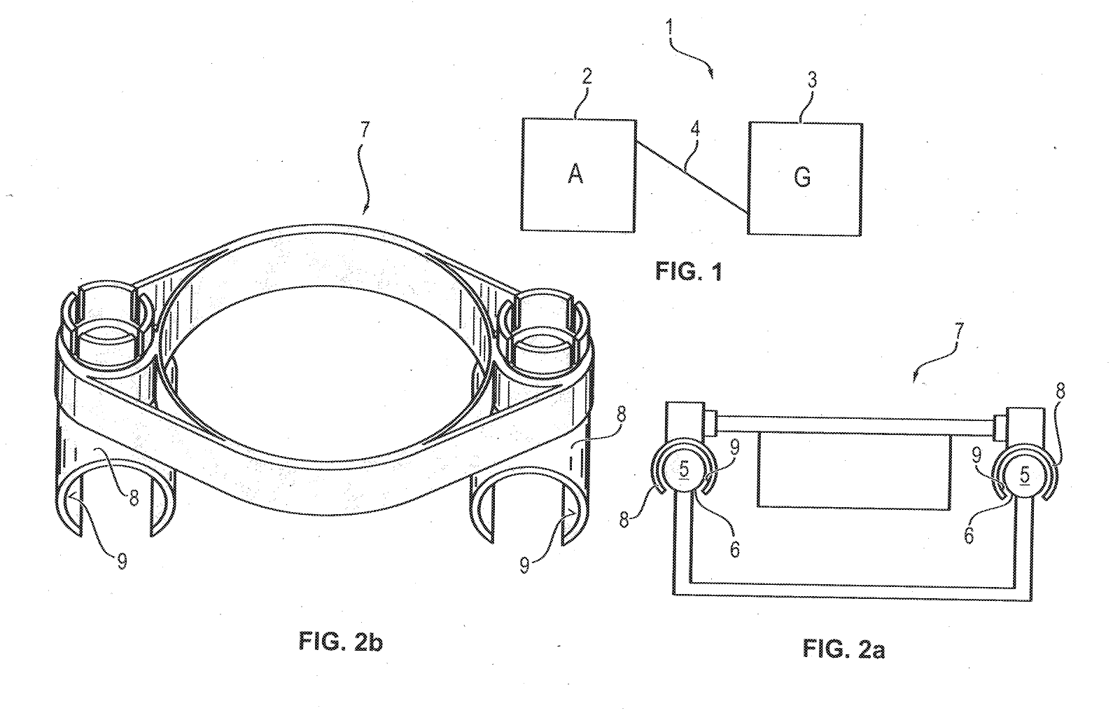

FIG. 2a shows an exemplary embodiment of a transport system of a restaurant system according to the invention in cross section;

FIG. 2b shows an exemplary embodiment of a transport means of a restaurant system according to the invention in a three-dimensional view;

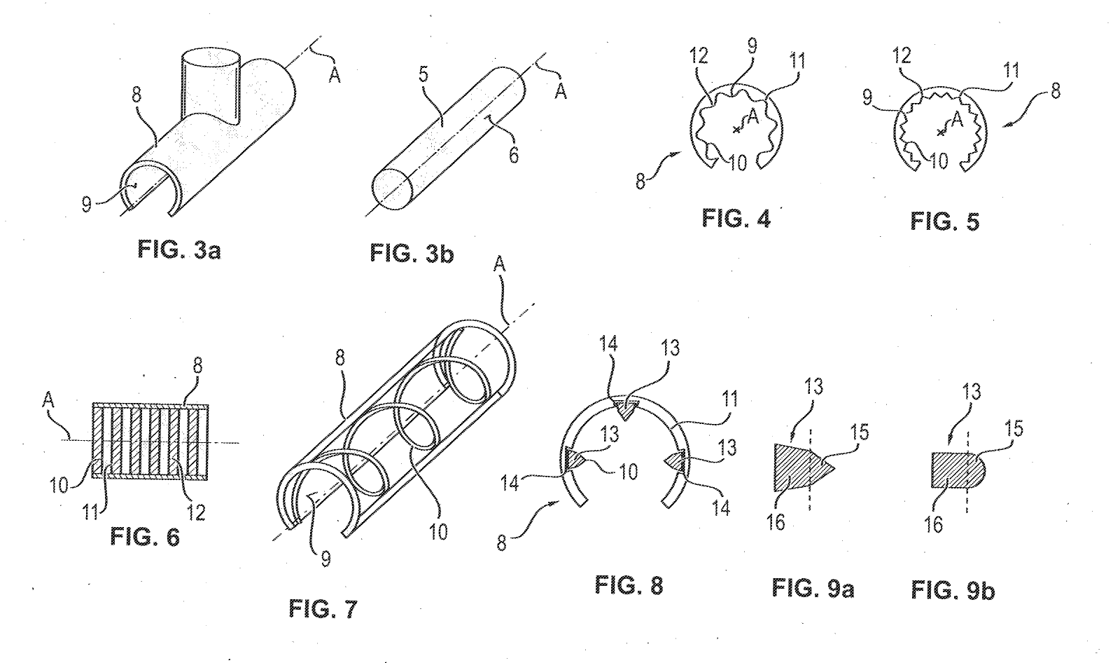

FIG. 3a shows an exemplary embodiment of a guide component of a restaurant system according to the invention in a three-dimensional view;

FIG. 3b shows an exemplary embodiment of a sliding rail of a restaurant system according to the invention in a three-dimensional view;

FIG. 4 shows a first exemplary embodiment of a guide component of a restaurant system according to the invention in cross section vertically to the center axis;

FIG. 5 shows a second exemplary embodiment of a guide component of a restaurant system according to the invention in cross section vertically to the center axis;

FIG. 6 shows a third exemplary embodiment of a guide component of a restaurant system according to the invention in cross section parallel to the center axis;

FIG. 7 shows a fourth exemplary embodiment of a guide component of a restaurant system according to the invention in a basic view;

FIG. 8 shows a fifth exemplary embodiment of a guide component of a restaurant system according to the invention in cross section vertically to the center axis;

FIG. 9a shows a first exemplary embodiment of a profile means of a restaurant system according to the invention in cross section vertically to the center axis;

FIG. 9b shows a second exemplary embodiment of a profile means of a restaurant system according to the invention in cross section vertically to the center axis.

Corresponding parts and components in FIG. 1 to FIG. 9, also beyond the different exemplary embodiments, are identified with the same reference numerals.

FIG. 1 shows a restaurant system 1 according to the invention comprising at least one working area 2 for cooking and/or preparing food and/or drinks and a guest area 3. Working area 2 and guest area 3 are connected via a transport system 4 for food and/or drinks. The transport system 4 is designed to transport food and/or drinks from the working area 2 to the guest area 3, wherein the transport of food and/or drinks from the working area 2 to the guest area 3 via the transport system 4 takes place at least in sections by means of the force of gravity.

FIG. 2a shows an exemplary embodiment of a transport system 4. The transport system 4 comprising a sliding rail system comprising two sliding rails 5. The sliding rails 5 form sliding rail surfaces 6 and the transport means 7 comprise guide components 8 comprising sliding surfaces 9. The guide components 8 encompass at least two thirds of the sliding rail circumference. FIG. 2b shows an exemplary embodiment of the transport means 7 in a three-dimensional view. The transport means 7 is embodied for transporting containers, in particular pots and/or dishes, preferably sliding bowls and/or sliding plates and/or sliding pots and/or sliding pans and/or glasses and/or cups and/or bottles and/or carafes and/or fast food packaging, for food and drinks, wherein the containers can be placed into the transport means 7 in a stable manner.

FIG. 3a shows an exemplary embodiment of a guide component 8 with the sliding surface 9 thereof in a three-dimensional view. FIG. 3b shows an exemplary embodiment of a sliding rail 5 with the sliding rail surface 6 thereof in a three-dimensional view.

FIG. 4 shows a first exemplary embodiment of a guide component 8 in cross section vertically to the center axis A thereof. The sliding surface 9 has a profile 12 for improving the sliding properties of the transport means 7. The profile 12 is formed by elevations 10, for establishing contact between sliding rails 5 and transport means 7, and by depressions 11, for reducing the frictional surface and/or for discharging dirt and/or abrasion products. The elevations 10 and depressions 11 are formed parallel to the center axis A and alternate. The elevations 10 and depressions 11 are formed with a sinusoidal cross section. The illustrated profile 12 forms nine elevations 10 and eight depressions 11, wherein a different number can also be chosen.

FIG. 5 shows a second exemplary embodiment of a guide component 8 in cross section vertically to the center axis A. The sliding surface 9 has a profile 12 for improving the sliding properties of the transport means 7. The profile 12 is formed by elevations 10, for establishing contact between sliding rails 5 and transport means 7, and by depressions 11, for reducing the frictional surface and/or for discharging dirt and/or abrasion products. The elevations 10 and depressions 11 are formed parallel to the center axis A and alternate. The elevations 10 and depressions 11 are formed with a triangular cross section. The illustrated profile 12 forms seventeen elevations 10 and sixteen depressions 11, wherein a different number can also be chosen.

FIG. 6 shows a third exemplary embodiment of a guide component 8 in cross section parallel to the center axis A. The sliding surface 9 has a profile 12 for improving the sliding properties of the transport means 7. The profile 12 is formed by elevations 10, for establishing contact between sliding rails 5 and transport means 7, and by depressions 11, for reducing the frictional surface and/or for discharging dirt and/or abrasion products. The elevations 10 and depressions 1 are formed vertically to the center axis A and alternate. The elevations 10 and depressions 11 can be formed to have a triangular cross section, but other shapes, for example a sinusoidal design, are also possible. The illustrated profile 12 forms seven elevations 10 and seven depressions 11, wherein a different number can also be chosen.

FIG. 7 shows a fourth exemplary embodiment of a guide component 8 in a basic view. The sliding surface 9 has a profile 12 for improving the sliding properties of the transport means 7. The profile 12 is formed by an elevation 10, for establishing contact between sliding rails 5 and transport means 7. The elevation 10 runs helically about the center axis A. The elevation 10 can be formed to have a sinusoidal cross section, but other shapes, for example a triangular shape, are also possible. In the alternative, the elevation 10 can also be a depression (not illustrated in the figures).

FIG. 8 shows a fifth exemplary embodiment of a guide component 8 in cross section vertically to the center axis A. The sliding surface 9 has a profile 12 for improving the sliding properties of the transport means 7. The profile 12 is formed by elevations 10, for establishing contact between sliding rails 5 and transport means 7, and by depressions 11, for reducing the frictional surface and/or for discharging dirt and/or abrasion products.

To generate the profile 12 on the sliding surfaces 9, provision is made for profile means 13, which are partially arranged in the guide components 8. The profile means 13 and the guide components 8 can differ with regard to the sliding properties of their material, wherein, for example, the profile means 13 consist of a material, which has better sliding properties than the material of the transport means 7.

The guide components 8 have recesses 14 for receiving the profile means 13, wherein the recesses 14 are formed parallel to the center axis A of the guide components 8. The cross sections of the recesses 14 are formed so as to be substantially trapezoidal, wherein other cross sectional shapes are also possible.

The profile means 13 in each case have a sliding section 15, wherein the sliding section 15 is formed to have a triangular cross section. Other shapes are possible as well here.

In the installed state of the profile means 13, each sliding section 15 of the profile means 13 forms an elevation 10 of the profile 12 and the sliding surface 9 embodies the depressions 11 of the profile 12.

FIG. 9a shows a first exemplary embodiment of a profile means 13 in cross section vertically to the center axis. The profile means 13 has a sliding section 15 and a connection section 16. The shape of the connection section 16 corresponds to the recesses 14 of the guide components 8 and is provided for connection to the guide components 8. The sliding section 15 is formed to have a triangular cross section, so as to improve the sliding properties of the transport means 7.

FIG. 9b shows a second exemplary embodiment of a profile means 13 in cross section vertically to the center axis. The profile means 13 has a sliding section 15 and a connection section 16. The shape of the connection section 16 corresponds to the recesses 14 of the guide components 8 and is provided for connection to the guide components 8. The sliding section 15 is formed so as to have a semicircular cross section, so as to improve the sliding properties of the transport means 7.

Further alternative cross sectional shapes of the sliding section 15 as well as of the connection section 16 of the profile means 13 are possible.

### LIST OF REFERENCE NUMERALS

1 restaurant system
2 working area
3 guest area
4 transport system
5 sliding rail
6 sliding rail surface
7 transport means
8 guide component
9 sliding surface
10 elevation
11 depression
12 profile
13 profile means
14 recess
15 sliding section
16 connection section
A center axis

1. A restaurant system (1) comprising
a) at least one working area (2) for cooking and/or preparing food and/or drinks,
b) at least one guest area (3), in particular comprising one or a plurality of tables for restaurant guests,
c) wherein working area (2) and guest area (3) are connected via a transport system (4) for food and/or drinks,
d) wherein the transport system (4) is designed to transport food and/or drinks from the working area (2) to the guest area (3), and
e) wherein the transport of food and/or drinks from the working area (2) to the guest area (3) takes place via the transport system (4) at least in sections by means of the force of gravity,
f) wherein the transport system (4) comprises a sliding rail system comprising one or a plurality of sliding rail paths and/or comprising at least one sliding rail (5), wherein the sliding rails (5) form sliding rail surfaces (6), and
g) wherein provision is made for transport means (7), in particular sliding supports and/or sliding devices, wherein the transport means (7) comprise guide components (8) comprising sliding surface (9), characterized in
h) that the sliding surfaces (9) and/or the sliding rail surfaces (6) have a profile (12) for improving the sliding properties of the transport means (7).

2. The restaurant system according to claim 1,
characterized in that
the profile (12) is formed by elevations (10), for establishing contact between sliding rails (5) and transport means (7), and/or by depressions (11), for reducing the frictional surface and/or for discharging dirt and/or abrasion products.

3. The restaurant system according to claim 2,
characterized in that
the elevations (10) and/or depressions (11) are formed parallel or vertically to the center axis (A) or run
helically about the center axis (A).

4. The restaurant system according to claim 2,
characterized in that
elevations (10) and depressions (11) alternate, so that a profile (12) is formed.

5. The restaurant system according to claim 2, characterized in that
the elevations (10) and/or depressions (11) are formed so as to have a semicircular and/or semi oval and/or sinusoidal and/or triangular and/or trapezoidal cross section.

6. The restaurant system according to claim 2, characterized in that
the profile (12) embodies at least one or at least two or at least three or more elevations (10) and/or depressions (11).

7. The restaurant system according to claim 1,
characterized in that
provision is made on the sliding surfaces (9) and/or sliding rail surfaces (6) for profile means (13), which are arranged on or at least partially in the guide components (8) and/or sliding rails (5), for generating a profile (12).

8. The restaurant system according to claim 7,
characterized in that
the profile means (13) on the one hand and guide components (8) and/or sliding rails (5) on the other hand differ with regard to their material, in particular with regard to the sliding properties of their material.

9. The restaurant system according to claim 7,
characterized in that
the guide components (8) and/or sliding rails (5) have recesses (14) for receiving the profile means (13), wherein the recesses (14) are formed parallel or vertically to the center axis (A) or run helically about the center axis (A).

10. The restaurant system according to claim 9,
characterized in that
the recesses (14) are formed so as to have a substantially trapezoidal cross section.

11. The restaurant system according to claim 7, characterized in that
the profile means (13) have a sliding section (15) and a connection section (16), wherein the shape of the connection section (16) corresponds to the recesses (14) of the guide components (8) and/or the sliding rails (5) and is provided for connection to the guide components (8) and/or the sliding rails (5), and wherein the sliding section (15) is formed to have a semicircular and/or semi oval and/or sinusoidal and/or triangular and/or trapezoidal cross section, so as to improve the sliding properties of the transport means (7).

12. The restaurant system according to claim 11,
characterized in that
the sliding section (15) of the profile means (13), in the installed state of the profile means (13), embodies the elevation (10) of the profile (12), and/or the sliding surface (9) and/or sliding rail surface (6) embodies the depression (11) of the profile (12).

13. The restaurant system according to claim 1,
characterized in that
the guide components (8) encompass the sliding rails (5) at least partially; in particular, they encompass at least half of the sliding rail circumference, preferably at least two thirds of the sliding rail circumference.

14. The restaurant system according to claim 1,
characterized in that
the transport means (7) are formed for the transport of containers, in particular pots and/or dishes, preferably sliding bowls and/or sliding plates and/or sliding pots and/or sliding pans and/or glasses and/or cups and/or bottles and/or carafes and/or fast food packaging, for food and drinks, wherein the containers can preferably be placed into or onto the transport means (7) in a stable manner.
